(19) United States
(12) Patent Application Publication
(10) Pub. No.: US 2025/0335287 A1
(43) Pub. Date: Oct. 30, 2025

(54) METHOD, SYSTEM, DEVICE AND MEDIUM FOR VERIFYING SYSTEM FLOW SWITCHING

(71) Applicant: Beijing Zitiao Network Technology Co., Ltd., Beijing (CN)

(72) Inventors: Hongbo Zhang, Beijing (CN); Yuan Wang, Beijing (CN)

(21) Appl. No.: 19/188,926

(22) Filed: Apr. 24, 2025

(30) Foreign Application Priority Data
Apr. 26, 2024 (CN) 202410512922.4

(51) Int. Cl. G06F 11/07

(52) U.S. Cl. CPC G06F 11/079; G06F 11/0709

(57) ABSTRACT

Embodiments of the disclosure provide a method, system, device and medium for verifying system flow switching. The method includes: in response to a flow switching verification request, performing, by an initiation server, a target operation, and triggering a target event for a verification server; in response to the target event, driving, by the verification server, a user interface test for the target system, obtaining a sequence of a plurality of services of the target system triggered to be accessed through the user interface test and a plurality of pieces of first computer room information corresponding to the plurality of services respectively; obtaining second computer room information corresponding to a domain name of a target domain triggered to be accessed through the user interface test; and determining a verification result based on the sequence, the first computer room information and the second computer room information.

### CROSS-REFERENCE

This application claims the benefit of Chinese Patent Application No. 202410512922.4 filed on Apr. 26, 2024, entitled “METHOD, SYSTEM, DEVICE AND MEDIUM FOR VERIFYING SYSTEM FLOW SWITCHING”, which is incorporated herein by reference in its entirety.

### FIELD

Embodiments of the disclosure relate to the field of computer technologies, and in particular, to a method, system, device and medium for verifying system flow switching.

### BACKGROUND

Flow switching refers to transferring all or part of the flow processing of a system from one processing node, server or server cluster to another processing node, server or server cluster. Flow switching operation may be used to effectively ensure load balancing, ensure uninterrupted service, and may also be used for system failure tolerance or system maintenance. Flow switching verification means that, in order to check the effectiveness of the flow switching, the flow switching mechanism of the system is triggered to confirm whether the system can successfully switch the flow to the target processing server or cluster, and whether the core functions of the system can continue to work normally after the system flow switching. In the existing conventional flow switching verification schemes, mainly users start the flow switching task manually, and after confirming that the flow switching task has been completed through manual observation, they verify whether the system functions are normal after the flow switching manually. However, in this flow switching verification solution, for example, confirming whether the flow switching has been completed and whether the system functions are normal through manual means both take a long time, and the user operations are cumbersome, thus resulting in low overall flow switching verification efficiency.

### SUMMARY

The embodiments of the disclosure describe method, system, device and medium for verifying system flow switching.

According to a first aspect, a method for verifying system flow switching is provided, including:
in response to a flow switching verification request for a target system sent by a user, performing, by an initiation server, a target operation corresponding to the flow switching verification request for the target system, and triggering a target event for a verification server that corresponds to the flow switching verification request;
in response to the target event, driving, by the verification server, a user interface test for the target system, obtaining a sequence of a plurality of services of the target system triggered to be accessed through the user interface test and a plurality of pieces of first computer room information corresponding to the plurality of services respectively; and obtaining second computer room information corresponding to a domain name of a target domain triggered to be accessed through the user interface test; determining a verification result corresponding to the flow switching verification request based on the sequence, the first computer room information and the second computer room information.

According to a second aspect, a system for verifying system flow switching is provided, including:
an initiation server, configured to, in response to a flow switching verification request for a target system sent by a user, perform a target operation corresponding to the flow switching verification request for the target system, and trigger a target event for a verification server that corresponds to the flow switching verification request;
the verification server, configured to, in response to the target event, drive a user interface test for the target system, obtain a sequence of a plurality of services of the target system triggered to be accessed through the user interface test and a plurality of pieces of first computer room information corresponding to the plurality of services respectively; and obtain second computer room information corresponding to a domain name of a target domain triggered to be accessed through the user interface test; determine a verification result corresponding to the flow switching verification request based on the sequence, the first computer room information and the second computer room information.

According to a third aspect, a computer-readable storage medium is provided, which has a computer program stored thereon, the computer program, when executed in a computer, causing the computer to perform the method of the first aspect.

According to a fourth aspect, an electronic device is provided, which includes a memory and a processor, the memory having executable code stored therein, the processor, when executing the executable code, implementing the method of the first aspect.

According to the embodiments of the disclosure, method, system, device and medium for verifying system flow switching is provided. First, in response to a flow switching verification request for a target system sent by a user, perform, by an initiation server, a target operation corresponding to the flow switching verification request for the target system, and trigger a target event for a verification server that corresponds to the flow switching verification request. Then, in response to the target event, drive, by the verification server, a user interface test for the target system, obtain a sequence of a plurality of services of the target system triggered to be accessed through the user interface test and a plurality of pieces of first computer room information corresponding to the plurality of services respectively; and obtain second computer room information corresponding to a domain name of a target domain triggered to be accessed through the user interface test; determine a verification result corresponding to the flow switching verification request based on the sequence, the first computer room information and the second computer room information. Through the method, user operation may be greatly simplified, time consumed for flow switching verification may be reduced, and thus the efficiency of flow switching verification may be improved. Furthermore, the verification frequency in a specific verification period may be greatly increased, and the ability to discover system floe switching failures through the flow switching verification may be improved.

### BRIEF DESCRIPTION OF DRAWINGS

FIG. 1 shows a schematic diagram of a method for verifying system flow switching according to the embodiments of the disclosure;

FIG. 2 shows a schematic diagram of confirming the verification result by combining the domain name computer room, service computer room and interface test result according to the embodiments of the disclosure;

FIG. 3 shows a schematic flowchart of a method for verifying system flow switching according to the embodiments of the disclosure;

FIG. 4 shows a schematic diagram of post-flow-switching verification according to the embodiments of the disclosure;

FIG. 5 shows a schematic diagram of flow switching recovery verification according to the embodiments of the disclosure;

FIG. 6 shows a schematic diagram of pre-flow-switching verification according to the embodiments of the disclosure;

FIG. 7 shows a schematic block diagram of a system for verifying system flow switching according to the embodiments of the disclosure;

FIG. 8 shows a schematic structural diagram of an electronic device adapted for implementing the embodiments of the disclosure;

FIG. 9 shows a schematic structural diagram of a storage medium adapted for implementing the embodiments of the disclosure.

### DETAILED DESCRIPTION

The technical solutions provided in the disclosure are further described in detail below with reference to the accompanying drawings and embodiments. It is to be understood that the specific embodiments described herein are merely for explaining the relevant invention, rather than limiting the invention. In addition, it should be noted that, for the convenience of description, only the parts related to the disclosure are shown in the accompanying drawings. It should be noted that, in the case of no conflict, the embodiments of the present disclosure and the features in the embodiments may be combined with each other.

In the description of implementations of the disclosure, the term “include” and its similar expressions should be understood as open-ended inclusion, that is, “including but not limited to”. The term “based on” should be understood as “at least partially based on”. The terms “one/a kind of implementation” or “the implementation” should be understood as “at least one/a kind of implementation”. The term “some implementations” should be understood as “at least some implementations”. Other explicit and implicit definitions may also be included below.

As described above, flow switching refers to transferring the jobs of processing system flow data from a processing node, a server or a server cluster to another processing node, a server, or a server cluster. Flow switching operation may be used to effectively ensure load balancing, ensure uninterrupted service, and may also be used for system failure tolerance or system maintenance. Flow switching verification means that, in order to check the effectiveness of the flow switching, the flow switching mechanism of the system is triggered to confirm whether the system can successfully switch the flow to the target processing server or cluster, and whether the system core functions can continue to work normally after the system flow switching. In the existing conventional flow switching verification schemes, mainly users initiate the flow switching task manually. Then, for example, after a predetermined time, it is confirmed whether the flow switching task has been completed through manual observation, and after confirming the completion of the execution, it is verified whether the system functions are normal after the flow switching manually. However, in this flow switching verification scheme, for example, confirming whether the flow switching task has been completed and whether the system functions are normal through manual means both take a long time, and the user operations are cumbersome, thus resulting in low overall flow switching verification efficiency.

However, this flow switching verification scheme usually has the following problems: on the one hand, relying on confirming the completion of the flow switching operation and verifying whether the system functions are normal after the flow switching through manual means leads to cumbersome user operations. On the second hand, the execution time consumed by each manual operation is usually relatively long. For example, users manually check whether the domain name after the flow switching meets the expectations through local data fetch. After the flow switching operation, users have to wait for a predetermined time and then can confirm whether the flow switching operation has been completed by observing, for example, the system status panel. For another example, after confirming that the flow switching operation is completed, users manually execute the preset operation list to confirm whether the system functions are normal. On the third hand, since the user operation is cumbersome and the manual operation is time-consuming, the efficiency of the flow switching verification is low, and the verification frequency of the system to be verified within a specific verification period is low.

In order to solve the above technical problem, embodiments of the disclosure provide a method for system flow switching. FIG. 1 shows a schematic diagram of the method for verifying system flow switching according to the embodiments of the disclosure. As shown in FIG. 1, in some embodiments, the user may, for example, send a flow switching verification request to an initiation server. After receiving the flow switching verification request, the initiation server performs a target operation for the target system to be verified and triggers a target event corresponding to the flow switching verification request for the verification server. After receiving the target event, the verification server may drive a user interface test for the target system, obtain a sequence composed of a plurality of services of the target system triggered to be accessed through the user interface test, and computer room information corresponding to the plurality of services, and obtain second computer room information corresponding to a domain name of a target domain triggered to be accessed through the user interface test. Specifically, for example, an interface test server (or called as a UI test server) may be invoked to execute a user interface test task (or called as a UI test task), and based on the log analysis server to analyze the log records generated by the user interface test task to obtain the sequence composed of the above plurality of services and the computer room information (first computer room information) corresponding to each service in the sequence. For example, the domain name of the target domain may be obtained through the data fetch server, and the computer room information (the second computer room information) corresponding to the domain name may be determined through the preset domain name and the computer room mapping relationship in the configuration server. Then, the verification server may determine a verification result corresponding to the flow switching verification request based on the sequence, the first computer room information and the second computer room information and send the verification result to the user.

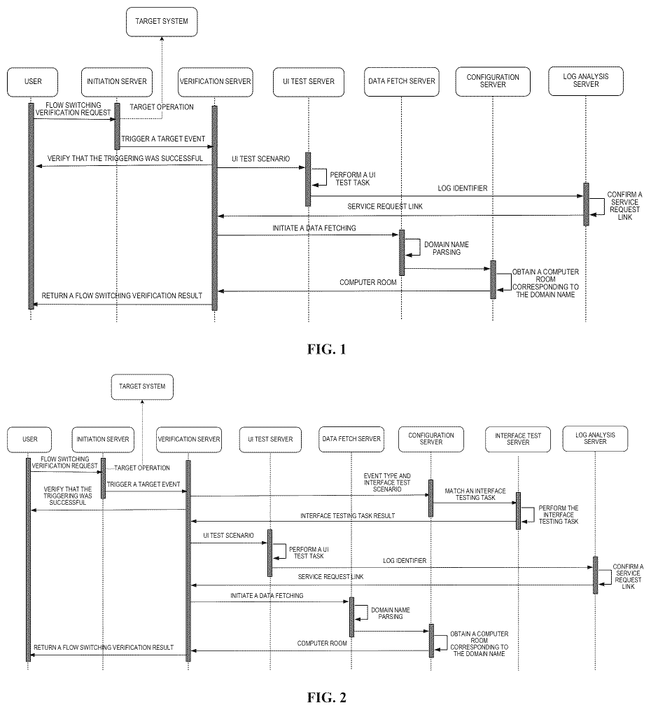

FIG. 2 shows a schematic diagram of confirming the verification result by combining the domain name computer room, the service computer room and the interface test result according to embodiments of the disclosure. As shown in FIG. 2, in some other embodiments, the interface test task of the application interface for the target system may also be determined by the configuration server, and the interface test task may be performed by the interface test server. The verification server may determine the flow switching verification result by combining the test result of the interface test task, the service sequence, the first computer room information and the second computer room information.

The advantages of this method are as follows: on one hand, by sending the flow switching verification request, the user can automatically complete the process from the flow switching operation of the system to the flow switching verification of the system, without the need for the user to manually observe whether the flow switching operation has been completed or to manually verify whether the system operates normally after the flow switching, which greatly simplifies user operations and reduces the quantity and difficulty of user operations. On the second hand, through this method, especially the time consumed for a single flow switching verification is reduced, the efficiency of the flow switching verification is improved, thus the frequency of the flow switching verification within a specific verification period may be greatly increased, and the ability to discover system flow switching failures through the flow switching verification is improved.

A detailed process of this method is further described below.

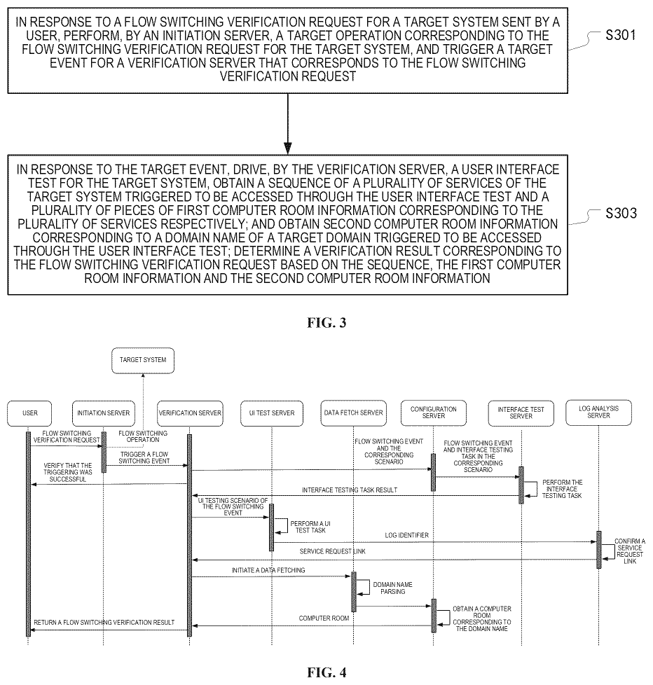

FIG. 3 shows a schematic flowchart of a method for verifying system flow switching according to embodiments of the disclosure. As shown in FIG. 3, the method includes at least the following steps:

Step S301, in response to a flow switching verification request for a target system sent by a user, performing, by an initiation server, a target operation corresponding to the flow switching verification request for the target system, and triggering a target event for a verification server that corresponds to the flow switching verification request;

Step S303, in response to the target event, driving, by the verification server, a user interface test for the target system, obtaining a sequence of a plurality of services of the target system triggered to be accessed through the user interface test and a plurality of pieces of first computer room information corresponding to the plurality of services respectively; and obtaining second computer room information corresponding to a domain name of a target domain triggered to be accessed through the user interface test; determining a verification result corresponding to the flow switching verification request based on the sequence, the first computer room information and the second computer room information.

First, in step S301, in response to a flow switching verification request for a target system sent by a user, performing, by an initiation server, a target operation corresponding to the flow switching verification request for the target system, and triggering a target event for a verification server that corresponds to the flow switching verification request.

The initiation server is a server that may receive user requests and initiate the verification process for the target system. In different embodiments, the initiation server may be specifically a physical server, a logical server, or a cloud server, or one of a server set composed of the above types of servers, which is not limited in this specification. Similarly, in subsequent steps, one or more of the verification server, the configuration server, the UI test server, the interface test server, the log analysis server and the data fetch server may be a physical server, a logical server, or a cloud server, or one of a server set composed of the above types of servers in different embodiments. To facilitate configuration in a production scenario, in different embodiments, logical steps performed by one or more of the above servers may also be performed by a same physical server, a logical server, a cloud server, or a server cluster in an actual production scenario, and one or more of the above servers may be a same physical server, a logical server, a cloud server, or a server cluster in an actual production scenario.

In this step, after receiving the flow switching verification request for the target system sent by the user, the initiation server may perform, for the target system, a target operation corresponding to the flow switching verification request and trigger a target event corresponding to the flow switching verification request for the verification server.

The target system refers to an application system for which the flow switching verification is targeted and whose application functions are implemented through or at least partially through software programs. In different embodiments, the target system may be an application system used for different specific services or specific purposes, which is not limited in this specification. In some embodiments, the flow switching verification request may include a test scenario (for example, a test scenario for a functional test or an interface test) that indicates this verification, and the initiation server may also indicate the test scenario in a parameter of the target event. In different embodiments, the specific test scenarios indicated by the flow switching verification request may be different.

In different embodiments, the specific flow switching verification request sent by the user for the target system may be different. FIG. 4 shows a schematic diagram of post-flow-switching verification according to embodiments of the disclosure. As shown in FIG. 4, in an embodiment, the flow switching verification request may include a post-flow-switching verification request. Thus, after receiving the post-flow-switching verification request sent by the user, the initiation server may perform the flow switching operation for the target system. The flow switching operation refers to transferring all or part of the flow processing of a system from one processing node, server or server cluster to another processing node, server or server cluster.

In different specific embodiments, the proportion of the transferred flow corresponding to the flow switching operation performed on the target system to the total flow of the target system may be different, which is not limited in this specification. For example, System A has Computer Room H1 and Computer Room H2, each including a calculator cluster, for data processing of flow, wherein the Computer Room H1 processes 50% of the total flow of System A, and the Computer Room H2 processes the remaining 50% flow currently, and the ratio of flow processing by the Computer Room H1 to the Computer Room H2 is 1:1. In an example, 10% of the flow processing may be transferred from the Computer Room H1 to the Computer Room H2 through the flow switching operation, making the ratio of flow processing between the two become 4:6. In another example, 15% of the flow processing may be transferred from the Computer Room H1 to the Computer Room H2 through the flow switching operation, making the ratio of the flow processing between the two become 35:65.

The initiation server may further trigger a flow switching event for the verification server according to the flow switching verification request. Triggering the rollback event for the verification server may enable the verification server to initiate the verification of the target system after rollback. Through the above ways, by sending the post-flow-switching verification request, the user may automatically perform the flow switching operation and automatically verify whether the flow switching operation is actually effective and whether the system functions operate normally in the subsequent steps, which greatly facilitates the verification of the user in the post-flow-switching time stage.

FIG. 5 shows a schematic diagram of flow switching recovery verification according to embodiments of the disclosure. As shown in FIG. 5, in another embodiment, the flow switching verification request may include a flow switching recovery verification request. Thus, after receiving the flow switching recovery verification request sent by the user, the initiation server may perform a flow switching rollback operation for the target system and trigger a rollback event for the verification server according to the flow switching recovery verification request. The flow switching rollback operation refers to restoring the proportion of flow processing of the target system by different computer rooms to a predetermined proportion under normal operation of the system. In the example of System A mentioned above, for example, under the normal operation of System A, the predetermined ratio of flow processing by the Computer Room H1 and the Computer Room H2 is 1:1. After one or more flow switching operations, the ratio of flow processing by the Computer Room H1 and the Computer Room H2 becomes 2:8. The ratio of flow processing by the Computer Room H1 and the Computer Room H2 may be restored to 1:1 through the flow switching rollback operation. Triggering the rollback event for the verification server may enable the verification server to initiate the verification of the target system after rollback. Through the above ways, by sending the flow switching rollback verification request, the user may automatically perform the flow switching rollback operation and automatically verify whether the flow switching rollback operation actually takes effect and whether the system functions operate normally in the subsequent steps, which greatly facilitates the verification of the user in the post-flow-switching rollback time stage.

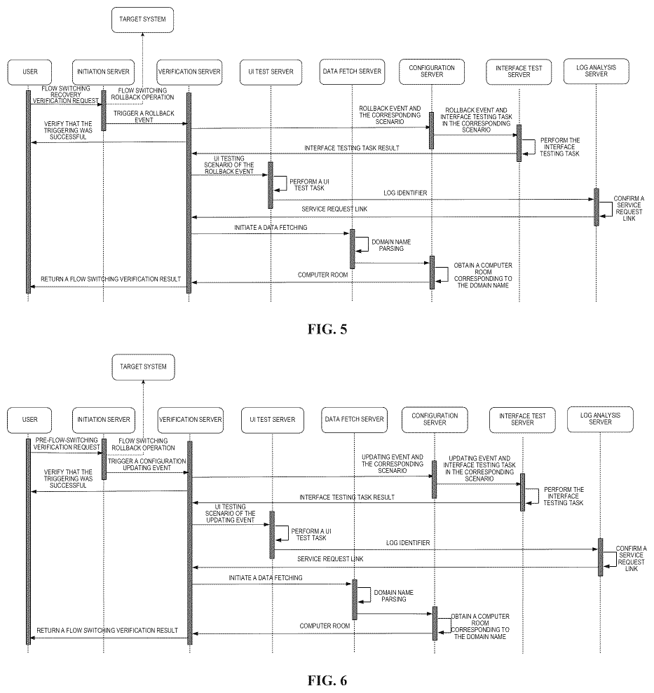

FIG. 6 shows a schematic diagram of pre-flow-switching verification according to embodiments of the disclosure. As shown in FIG. 6, in another embodiment, the flow switching verification request may further include a pre-flow-switching verification request. Thus, after receiving the pre-flow-switching verification request sent by the user, the initiation server may perform a null operation for the target system and trigger a configuration update event for the verification server according to the pre-flow-switching verification request. In an actual production scenario, as the version or function of the target system iterates, the configuration for verifying the target system is often updated accordingly (for example, the update of the test tasks for the latest version of the system), and triggering the configuration update event for the verification server may enable the verification server to initiate the verification of the target system before this flow switching operation. Through the above ways, the user may send a pre-flow-switching verification request to, for example, confirm whether the system functions operate normally before the flow switching operation, which facilitates the verification of the user in the pre-flow-switching time stage.

Then, in step S303, in response to the target event, the verification server may drive a user interface test for the target system, obtain a sequence of a plurality of services of the target system triggered to be accessed through the user interface test and a plurality of pieces of first computer room information corresponding to the plurality of services respectively, and obtain second computer room information corresponding to a domain name of a target domain triggered to be accessed through the user interface test. To prompt the user that the verification has started, in an embodiment, the verification server may further send a verification trigger success message to the user in response to the target event, as shown in FIG. 2.

The sequence of the plurality of services of the target system accessed by the user interface test and the computer room information (first computer room information) corresponding to each service may be used to determine a verification result of the flow switching verification. The computer room information may be the identification information of a logical room containing one or more servers or server clusters, and the logical room is used for managing server resources and is not limited to a single physical entity room. In different embodiments, the specific ways in which the verification server drives the user interface test for the target system and obtains the sequence of the plurality of services of the target system accessed by the user interface test and the plurality of pieces of first computer room information may be different. In an embodiment, the verification server may send a first scenario corresponding to the user interface test to an interface test server (UI test server); and the interface test server determines and performs an interface test task according to the first scenario (the interface test scenario). Then, the interface test server may send the identifier of the log record of the target system generated by the user interface test to the log analysis server; and the log analysis server determines, according to the identifier and the system log of the target system, the sequence composed of the plurality of services and the plurality of pieces of the first computer room information corresponding to the plurality of services, and sends the sequence and the first computer room information to the verification server. Since the system log includes the services accessed in the system and the information of the computer room containing the server or server cluster where the services run. Therefore, through the above ways, the sequence of the plurality of services and the computer room information corresponding to each service may be efficiently obtained by analyzing the log records of the system log generated by the UI test.

The computer room information (second computer room information) corresponding to the domain name of the target domain accessed by the user interface test may also be used to determine the verification result of the flow switching verification. In different embodiments, the specific ways to obtain the second computer room information may also be different. In an embodiment, a data fetch request may be sent to a data fetch server, the data fetch server obtains and parses a network data packet generated through the user interface test based on the data fetch request to obtain the domain name of the target domain; the data packet fetch service sends the domain name to a configuration server, and the configuration server determines a second computer room corresponding to the domain name according to a pre-configured domain name and a computer room mapping relationship, and sends the computer room information of the second computer room to the verification server. In different embodiments, the target domain may be different. In an embodiment, the target domain may be, for example, a domain where the load balancing server of the target system is located. Since the load balancing server is used to distribute access requests for various services in the target system, the order of accessing the load balancing server is prior to that of accessing various services in the target system. Through the above ways, the domain name of the target domain may be obtained by analyzing the network data packet generated by the UI test, and then the computer room information corresponding to the domain name may be efficiently determined through the pre-configured domain name and the computer room mapping relationship.

After determining the sequence of the plurality of services and the first computer room information, as well as the second computer room information, the verification result corresponding to the flow switching verification request may be determined according to the sequence and the first computer room information and the second computer room information. In different embodiments, the specific ways of determining the verification result corresponding to the flow switching verification request may be different. For example, the first verification result may be determined based on whether expected computer room information corresponding to a respective service in the sequence after the target operation matches the first computer room information corresponding to the respective service; the second verification result may be determined based on whether expected computer room information corresponding to the domain name after the target operation matches the second computer room information. The verification result corresponding to the flow switching verification request may be determined based on the first verification result and the second verification result. Through the above ways, it may be determined whether the flow switching operation or the flow switching rollback operation itself is actually effective according to whether the computer rooms where the system and each of its services actually run are, for example, the expected computer rooms after the flow switching or after the flow switching rollback.

The verification result of the flow switching verification may also be determined by combining the test result of the interface access test for the target system. Therefore, in another embodiment, in response to the target event, the verification server may further drive the interface access test for the target system. In a specific embodiment, the verification server may further drive an interface access test for the target system in response to the target event. Further, the verification result corresponding to the flow switching verification request may be determined according to the sequence, the first computer room information, the second computer room information, and the test result of the interface access test. The interface test task refers to a test task for an application programming interface (API) of a target system, such as a functional test task. Through the above ways, the verification result of the flow switching verification may be determined by combining the test result of the application interface of the target system, making it more accurate and comprehensive to determine the verification result corresponding to the flow switching verification request.

In different specific embodiments, the ways in which the verification server drives the interface access test may be different. In a specific embodiment, the verification server may send the event type of the target event and the second scenario corresponding to the interface access test to the configuration server, and the configuration server determines the interface test task according to the event type and the second scenario (the function test scenario), and invokes the interface test server to perform the interface test task; and the interface test server sends the test result of the interface test task to the verification server. In different embodiments of this embodiment, the functional test scenario and the interface test scenario may be the same or different. Through the above ways, the interface test task corresponding to the target event and its test scenario may be automatically matched and performed, reducing the workload of manually matching test tasks before verification and further improving the test efficiency.

In different embodiments, the specific ways of determining the flow switching verification result according to the sequence, the first computer room information, the second computer room information, and the test result of the interface access test may also be different. In an embodiment, the verification server may determine the first verification result based on whether expected computer room information corresponding to a respective service in the sequence after the target operation matches the first computer room information corresponding to the respective service; determine a second verification result based on whether expected computer room information corresponding to the domain name after the target operation matches the second computer room information; and determine a verification result corresponding to the flow switching verification request based on the first verification result, the second verification result, and the test result. Through the above ways, not only may it be determined whether the flow switching operation or the flow switching rollback operation itself is actually effective based on whether the computer rooms where the system and each of its services actually run are, for example, the expected computer rooms after the flow switching or after the flow switching rollback, but also may it be determined whether the system functions operate normally under the condition that the flow switching operation or the flow switching rollback operation is actually effective or partially effective (for example, the computer room switching of some services fails), making the verification result more accurate and comprehensive.

In order to prompt the user of the result of the flow switching verification request, in an embodiment, after confirming the verification result corresponding to the flow switching verification request, the verification server may send the verification result to the user. By sending the verification result, the user may also be enabled to initiate other requests related to the flow switching verification request. In an example, the user expects to initiate a flow switching recovery verification request after initiating a plurality of pre-flow-switching verification requests and post-flow-switching verification requests in sequence. Further, for example, after receiving the verification result of one of the post-flow-switching verification requests, the user may initiate a next pre-flow-switching verification request.

FIG. 7 shows a schematic block diagram of a system for verifying system flow switching according to embodiments of the disclosure. The system is configured to perform the method shown in FIG. 3. As shown in FIG. 7, the system 700 includes:

an initiation server 701, configured to, in response to a flow switching verification request for a target system sent by a user, perform a target operation corresponding to the flow switching verification request for the target system, and trigger a target event for a verification server that corresponds to the flow switching verification request;

an verification server 702, configured to, in response to the target event, drive a user interface test for the target system, obtain a sequence of a plurality of services of the target system triggered to be accessed through the user interface test and a plurality of pieces of first computer room information corresponding to the plurality of services respectively; and obtain second computer room information corresponding to a domain name of a target domain triggered to be accessed through the user interface test; determine a verification result corresponding to the flow switching verification request based on the sequence, the first computer room information and the second computer room information.

Embodiments of the disclosure further provides an electronic device, including a memory and a processor, the memory having executable code stored therein, the processor, when executing the executable code, implementing the method shown in FIG. 3.

The following may refer to FIG. 8, which shows a schematic structural diagram of an electronic device 800 adapted to implement the embodiments of this application. The electronic device 800 shown in FIG. 8 is merely an example and should not impose any limitation on the functions and the use scope of the embodiments of this application.

As shown in FIG. 8, the electronic device 800 may include a processing device (for example, a central processing unit, a graphics processing unit, etc.) 801. The processing device 801 may be a general-purpose processor, a digital signal processor (DSP), a microprocessor, or a microcontroller, or it may further include an application specific integrated circuit (ASIC), a field-programmable gate array (FPGA) or other programmable logic devices, discrete gates or transistor logic devices, or discrete hardware components, and it may perform various appropriate actions and processes according to the programs stored in a read-only memory (ROM) 802 or programs loaded from a storage device 808 into a random access memory (RAM) 803. In RAM 803, various programs and data required for the operation of the electronic device 800 are also stored. The processing device 801, ROM 802 and RAM 803 are connected to each other via a bus 804. Input/output (I/O) interface 805 is also connected to the bus 804.

Generally, the following devices may be connected to the I/O interface 805: an input device 806 including, for example, a touch screen, a touch pad, a keyboard, a mouse, etc.; an output device 807 including, for example, a liquid crystal display (LCD), a speaker, a vibrator, etc.; a storage device 808 including, for example, a magnetic tape, a hard disk, etc.; and a communication device 809. The communication device 809 may allow the electronic device 800 to communicate wirelessly or wired with other devices to exchange data. Although FIG. 8 shows an electronic device 800 with various devices, it should be understood that it is not required to implement or have all the illustrated devices. More or fewer devices may alternatively be implemented or provided. Each block shown in FIG. 8 may represent a single device or may represent multiple devices as required.

In particular, according to the embodiments of the application, the process described above with reference to the flowchart may be implemented as a computer software program. For example, the embodiments of the disclosure include a computer program product including a computer program carried on a computer-readable medium, the computer program including program code for performing the method shown in the flowchart. In such embodiments, the computer program may be downloaded and installed from the network through the communication device 809, or installed from the storage device 808, or installed from ROM 802. When the computer program is executed by the processing apparatus 801, the foregoing functions defined in the method for verifying system flow switching provided in the embodiments of this application are performed.

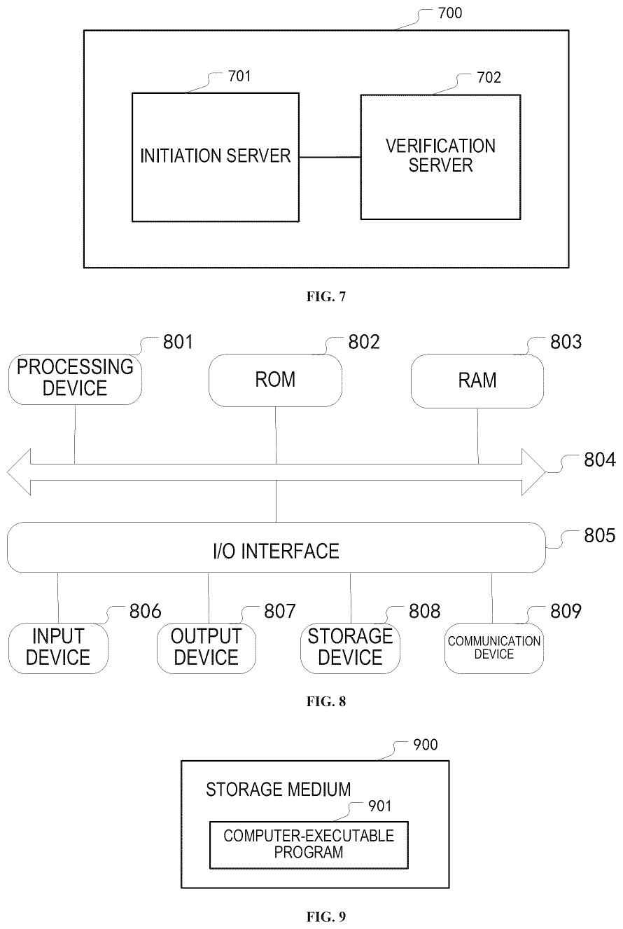

Embodiments of the disclosure further provides a computer-readable storage medium having a computer program stored thereon, and when the computer program is executed in a computer, it causes the computer to perform the method for verifying system flow switching as shown in FIG. 3 according embodiments of this application. FIG. 9 is a schematic diagram of a storage medium for implementing the embodiments of this application. For example, as shown in FIG. 9, the storage medium 900 may be a non-transitory computer-readable storage medium for storing non-transitory computer-executable instructions 901. When the non-transitory computer executable instructions 901 are executed by a processor, the method for verifying system flow switching provided in the embodiments of this application may be implemented, for example, when the non-transitory computer executable instructions 901 are executed by the processor, one or more steps in the method for verifying system flow switching provided by embodiments of this application may be performed. For example, the storage medium 900 may be applied to the electronic device, for example, the storage medium 900 may include a memory in the electronic device. For description of the storage medium 900, reference may be made to the description of the memory in the embodiments of the electronic device, and the repetitive parts will not be elaborated here. The specific functions and technical effects of the storage medium 900 may be referred to the description of the method for verifying system flow switching provided in the embodiments of this application and will not be elaborated here.

It should be noted that the computer-readable medium of the embodiments of the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, device, or device, or any combination thereof. More specific examples of the computer-readable storage media may include, but are not limited to, an electrical connection having one or more wires, a memory card of a smartphone, a storage component of a tablet, a portable computer diskette, a hard disk of a personal computer, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In embodiments of the present disclosure, a computer-readable storage medium may be any tangible medium containing or storing a program that may be used by or in connection with an instruction execution system, apparatus, or device. In the embodiments of the present disclosure, the computer-readable signal medium may include a data signal propagated in baseband or as part of a carrier, where the computer readable program code is carried. Such a propagating data signal may take a variety of forms including, but not limited to, electromagnetic signals, optical signals, or any suitable combination of the foregoing. The computer-readable signal medium may also be any computer-readable medium other than a computer-readable storage medium that may send, propagate, or transmit a program for use by or in connection with an instruction execution system, apparatus, or device. The program code included on the computer-readable medium may be transmitted by any appropriate medium, including but not limited to wires, optical cables, Radio Frequency (RF), and the like, or any appropriate combination thereof.

The computer-readable medium described above may be included in the electronic device; or may exist independently without being assembled into the electronic device. The computer-readable medium carries one or more programs, and when the one or more programs are executed by the server, the electronic device is caused to implement the method for verifying system flow switching provided in the embodiments of the application.

The computer program code for performing the operations of the embodiments of the disclosure may be written in one or more programming languages or combinations thereof, including an object-oriented programming language such as Java, Smalltalk, C++, and also conventional procedural programming languages, such as the “C” language or similar programming languages. The program code may be executed completely on a user computer, partially on the user computer, as an independent software package, partially on the user computer, partially on a remote computer, or completely on the remote computer or server. In the case of involving the remote computer, the remote computer may be connected to the user computer through any kind of network, including a local area network (LAN) or a wide area network (WAN), or may be connected to an external computer (e.g., connected through the Internet by using an Internet service provider).

The flowcharts and block diagrams in the accompanying drawings illustrate the possible implementation architectures, functions, and operations of systems, methods, and computer program products according to various embodiments of the disclosure. In this regard, each block in the flowchart or block diagram may represent a module, program segment, or a part of the code that includes one or more executable instructions for implementing the specified logical function. It should also be noted that in some alternative implementations, the functions labeled in the blocks may also occur in a different order from that labeled in the accompanying drawings. For example, two consecutively represented blocks may actually be performed substantially in parallel, which may sometimes be performed in the reverse order, depending on the functions involved. It is also noted that each block in the block diagrams and/or flowcharts, as well as combinations of blocks in the block diagrams and/or flowcharts, may be implemented by a dedicated hardware-based system that performs the specified functions or operations, or may be implemented by a combination of dedicated hardware and computer instructions. The units involved in the embodiments of the disclosure may be implemented by software, or may be implemented by hardware. The name of the unit does not constitute a limitation on the unit itself in some cases. The functions described above may be performed, at least in part, by one or more hardware logic components. For example, without limitation, exemplary types of hardware logic components that may be used include field programmable gate arrays (FPGAs), application specific integrated circuits (ASICs), application specific standard products (ASSPs), system-on-a-chip (SOCs), complex programmable logic devices (CPLDs), etc.

Various embodiments in this specification are described in a progressive manner, and for the parts that are the same or similar among the various embodiments, reference may be made to each other, and each embodiment focuses on differences from other embodiments. In particular, for the storage medium and the computing device embodiments, since they are substantially similar to the method embodiments, the description is relatively simple, and reference may be made to the relevant parts of the method embodiments for details.

The above description is only the preferred embodiments of the disclosure and an explanation of the applied technical principles. It should be understood by those skilled in the art that the scope of disclosure involved in the disclosure is not limited to the technical solutions formed by the specific combination of the above technical features and should also cover other technical solutions formed by any combination of the above technical features or their equivalent features without departing from the above disclosed concept. For example, the technical solutions formed by replacing the above features with the technical features having similar functions disclosed in the disclosure (but not limited to). In addition, although the operations are depicted in a particular order, this should not be understood as requiring these operations to be performed in the particular order shown or in a sequential order. In certain circumstances, multitasking and parallel processing may be advantageous. Similarly, although several specific implementation details are included in the discussion above, these should not be interpreted as limiting the scope of the disclosure. Certain features described in the context of a single embodiment may also be implemented in combination in a single embodiment. Conversely, the various features described in the context of a single embodiment may also be implemented in multiple embodiments either individually or in any suitable sub-combination.

The above specific implementations further elaborate on the purpose, technical solution, and beneficial effects of the embodiments of the invention. Although the subject matter has been described using language specific to structural features and/or method logical acts, it should be understood that the subject matter defined in the appended claims is not necessarily limited to the specific features or acts described above. Instead, the specific features and acts described above are merely exemplary forms of implementing the claims. It should be understood that the above is only the specific implementation of the embodiments of the disclosure and is not intended to limit the protection scope of the disclosure, and any modification, equivalent substitution, improvement and the like made on the basis of the technical solutions of the disclosure should be included within the protection scope of the disclosure.

I/We claim:

1. A method for verifying system flow switching, comprising:
in response to a flow switching verification request for a target system sent by a user, performing, by an initiation server, a target operation corresponding to the flow switching verification request for the target system, and triggering a target event for a verification server that corresponds to the flow switching verification request; and
in response to the target event, driving, by the verification server, a user interface test for the target system, obtaining a sequence of a plurality of services of the target system triggered to be accessed through the user interface test and a plurality of pieces of first computer room information corresponding to the plurality of services respectively; obtaining second computer room information corresponding to a domain name of a target domain triggered to be accessed through the user interface test; and determining a verification result corresponding to the flow switching verification request based on the sequence, the first computer room information and the second computer room information.

2. The method of claim 1, wherein driving, by the verification server, a user interface test for the target system, obtaining a sequence of a plurality of services of the target system triggered to be accessed through the user interface test and a plurality of pieces of first computer room information corresponding to the plurality of services respectively comprises:
sending, by the verification server, a first scenario corresponding to the user interface test to an interface test server; determining and performing, by the interface test server, an interface test task based on the first scenario;
sending, by the interface test server, an identifier of a log record of the target system generated through the user interface test to a log analysis server; and
determining, by the log analysis server, the sequence composed of the plurality of services and the plurality of pieces of first computer room information corresponding to the plurality of services based on the identifier and a system log of the target system, and sending the sequence and the first computer room information to the verification server.

3. The method of claim 1, wherein obtaining the second computer room information corresponding to the domain name of the target domain triggered to be accessed through the user interface test comprises:
sending a data fetch request to a data fetch server, the data fetch server obtaining and parsing a network data packet generated through the user interface test based on the data fetch request to obtain the domain name of the target domain; and
sending, the data packet fetch service, the domain name to a configuration server, the configuration server determining a second computer room corresponding to the domain name based on a pre-configured mapping relationship between domain names and computer rooms, and sending computer room information of the second computer room to the verification server.

4. The method of claim 1, further comprising: in response to the target event, driving, by the verification server, an interface access test for the target system, and
wherein determining a verification result corresponding to the flow switching verification request based on the sequence, the first computer room information and the second computer room information comprises:
determining the verification result corresponding to the flow switching verification request according to the sequence, the first computer room information, the second computer room information, and a test result of the interface access test.

5. The method of claim 4, wherein driving, by the verification server, an interface access test for the target system comprises:
sending, by the verification server, an event type of the target event and a second scenario corresponding to the interface access test to the configuration server;
determining, by the configuration server, an interface test task based on the event type and the second scenario, and invoking an interface test server to perform the interface test task; and
sending, by the interface test server, a test result of the interface test task to the verification server.

6. The method of claim 4, wherein determining the verification result corresponding to the flow switching verification request according to the sequence, the first computer room information, the second computer room information, and a test result of the interface access test comprises:
determining a first verification result based on whether expected computer room information corresponding to a respective service in the sequence after the target operation matches the first computer room information corresponding to the respective service;
determining a second verification result based on whether expected computer room information corresponding to the domain name after the target operation matches the second computer room information; and
determining the verification result corresponding to the flow switching verification request based on the first verification result, the second verification result, and the test result.

7. The method of claim 1, wherein the flow switching verification request comprises a post-flow-switching verification request, and
wherein in response to a flow switching verification request for a target system sent by a user, performing, by an initiation server, a target operation corresponding to the flow switching verification request for the target system, and triggering a target event for a verification server that corresponds to the flow switching verification request comprises:
receiving the post-flow-switching verification request sent by the user;
performing a flow switching operation for the target system; and
triggering a post-flow-switching verification event for the verification server according to the post-flow-switching verification request.

8. The method of claim 1, wherein the flow switching verification request comprises a flow switching recovery verification request, and
wherein in response to a flow switching verification request for a target system sent by a user, performing, by an initiation server, a target operation corresponding to the flow switching verification request for the target system, and triggering a target event for a verification server that corresponds to the flow switching verification request comprises:
receiving the flow switching recovery verification request sent by the user;
performing a flow switching rollback operation for the target system; and
triggering a flow switching recovery verification event for the verification server according to the flow switching recovery verification request.

9. The method of claim 1, wherein the flow switching verification request comprises a pre-flow-switching verification request, and
wherein in response to a flow switching verification request for a target system sent by a user, performing, by an initiation server, a target operation corresponding to the flow switching verification request for the target system, and triggering a target event for a verification server that corresponds to the flow switching verification request comprises:
receiving the pre-flow-switching verification request sent by the user;
performing a null operation for the target system; and
triggering a pre-flow-switching verification event for the verification server according to the pre-flow-switching verification request.

10. The method of claim 1, further comprising,
sending, by the verification server, the verification result to the user after the verification result is confirmed.

11. A non-transitory computer-readable storage medium, having a computer program stored thereon, the computer program, when executed in a computer, causing the computer to perform acts comprising:
in response to a flow switching verification request for a target system sent by a user, performing, by an initiation server, a target operation corresponding to the flow switching verification request for the target system, and triggering a target event for a verification server that corresponds to the flow switching verification request; and
in response to the target event, driving, by the verification server, a user interface test for the target system, obtaining a sequence of a plurality of services of the target system triggered to be accessed through the user interface test and a plurality of pieces of first computer room information corresponding to the plurality of services respectively; obtaining second computer room information corresponding to a domain name of a target domain triggered to be accessed through the user interface test; and determining a verification result corresponding to the flow switching verification request based on the sequence, the first computer room information and the second computer room information.

12. An electronic device, comprising a memory and a processor, the memory having executable code stored therein, the processor, when executing the executable code, implementing acts comprising:
in response to a flow switching verification request for a target system sent by a user, performing, by an initiation server, a target operation corresponding to the flow switching verification request for the target system, and triggering a target event for a verification server that corresponds to the flow switching verification request; and
in response to the target event, driving, by the verification server, a user interface test for the target system, obtaining a sequence of a plurality of services of the target system triggered to be accessed through the user interface test and a plurality of pieces of first computer room information corresponding to the plurality of services respectively; obtaining second computer room information corresponding to a domain name of a target domain triggered to be accessed through the user interface test; and determining a verification result corresponding to the flow switching verification request based on the sequence, the first computer room information and the second computer room information.

13. The electronic device of claim 12, wherein driving, by the verification server, a user interface test for the target system, obtaining a sequence of a plurality of services of the target system triggered to be accessed through the user interface test and a plurality of pieces of first computer room information corresponding to the plurality of services respectively comprises:
sending, by the verification server, a first scenario corresponding to the user interface test to an interface test server; determining and performing, by the interface test server, an interface test task based on the first scenario;
sending, by the interface test server, an identifier of a log record of the target system generated through the user interface test to a log analysis server; and
determining, by the log analysis server, the sequence composed of the plurality of services and the plurality of pieces of first computer room information corresponding to the plurality of services based on the identifier and a system log of the target system, and sending the sequence and the first computer room information to the verification server.

14. The electronic device of claim 12, wherein obtaining the second computer room information corresponding to the domain name of the target domain triggered to be accessed through the user interface test comprises:
sending a data fetch request to a data fetch server, the data fetch server obtaining and parsing a network data packet generated through the user interface test based on the data fetch request to obtain the domain name of the target domain; and
sending, the data packet fetch service, the domain name to a configuration server, the configuration server determining a second computer room corresponding to the domain name based on a pre-configured mapping relationship between domain names and computer rooms, and sending computer room information of the second computer room to the verification server.

15. The electronic device of claim 12, the acts further comprising: in response to the target event, driving, by the verification server, an interface access test for the target system, and
wherein determining a verification result corresponding to the flow switching verification request based on the sequence, the first computer room information and the second computer room information comprises:
determining the verification result corresponding to the flow switching verification request according to the sequence, the first computer room information, the second computer room information, and a test result of the interface access test.

16. The electronic device of claim 15, wherein driving, by the verification server, an interface access test for the target system comprises:
sending, by the verification server, an event type of the target event and a second scenario corresponding to the interface access test to the configuration server;
determining, by the configuration server, an interface test task based on the event type and the second scenario, and invoking an interface test server to perform the interface test task; and
sending, by the interface test server, a test result of the interface test task to the verification server.

17. The electronic device of claim 15, wherein determining the verification result corresponding to the flow switching verification request according to the sequence, the first computer room information, the second computer room information, and a test result of the interface access test comprises:
determining a first verification result based on whether expected computer room information corresponding to a respective service in the sequence after the target operation matches the first computer room information corresponding to the respective service;
determining a second verification result based on whether expected computer room information corresponding to the domain name after the target operation matches the second computer room information; and
determining the verification result corresponding to the flow switching verification request based on the first verification result, the second verification result, and the test result.

18. The electronic device of claim 12, wherein the flow switching verification request comprises a post-flow-switching verification request, and
wherein in response to a flow switching verification request for a target system sent by a user, performing, by an initiation server, a target operation corresponding to the flow switching verification request for the target system, and triggering a target event for a verification server that corresponds to the flow switching verification request comprises:
receiving the post-flow-switching verification request sent by the user;
performing a flow switching operation for the target system; and
triggering a post-flow-switching verification event for the verification server according to the post-flow-switching verification request.

19. The electronic device of claim 12, wherein the flow switching verification request comprises a flow switching recovery verification request, and
wherein in response to a flow switching verification request for a target system sent by a user, performing, by an initiation server, a target operation corresponding to the flow switching verification request for the target system, and triggering a target event for a verification server that corresponds to the flow switching verification request comprises:
receiving the flow switching recovery verification request sent by the user;
performing a flow switching rollback operation for the target system; and
triggering a flow switching recovery verification event for the verification server according to the flow switching recovery verification request.

20. The electronic device of claim 12, wherein the flow switching verification request comprises a pre-flow-switching verification request, and
wherein in response to a flow switching verification request for a target system sent by a user, performing, by an initiation server, a target operation corresponding to the flow switching verification request for the target system, and triggering a target event for a verification server that corresponds to the flow switching verification request comprises:
receiving the pre-flow-switching verification request sent by the user;
performing a null operation for the target system; and
triggering a pre-flow-switching verification event for the verification server according to the pre-flow-switching verification request.
